(19) United States
(12) Patent Application Publication
(10) Pub. No.: US 2006/0086253 A1
(43) Pub. Date: Apr. 27, 2006

(54) Cyclone separator cooler

(76) Inventors: Siddhartha Gaur, Plano, TX (US); Vibha Bansal, Plano, TX (US)

Correspondence Address: OSHA LIANG L.L.P., 1221 MCKINNEY STREET, SUITE 2800, HOUSTON, TX, 77010, US

(21) Appl. No.: 10/974,360

(22) Filed: Oct. 27, 2004

(51) Int. Cl. B01D 47/00

(52) U.S. Cl. 96/321

(57) ABSTRACT

A cyclone separator cooler separates particles from an injected mixture of gas and particulate matter. The inside of the cyclone separator is provided with a flow of liquid. An inside wall of the cyclone separator is at least partially coated with the flowing liquid. Particulate solids in the injected gas and solids mixture are moved to the wall of the cyclone separator by centrifugal force and are removed along with the flow of liquid. The liquid facilitates separation and removal of the particles and also cools the cyclone separator and the gas mixture flowing through it.

### BACKGROUND OF INVENTION

1. Field of the Invention

The invention relates generally to a system and apparatus for separating particulate solids and condensable vapors from a gas stream and for cooling the gas stream. It pertains particularly to such a system which utilizes a cyclone separator and utilizes a cooling liquid.

2. Background Art

Many devices and methods have been developed for separation of particulate solid materials from gases, such as from hot combustion gases containing such particles. For example, U.S. Pat. No. 2,400,645 to Huff discloses a system for separating catalyst particles from gases containing such particles by utilizing a cyclone separator from which cleaned overhead gas is passed upwardly through a filtering zone formed by a bed of larger and smaller particles arranged in series. U.S. Pat. No. 4,110,088 to Cold et al. discloses apparatus for removing water-soluble pollutants and particles from flue gases by utilizing a gas-solids separator having a spray chamber located upstream of a cyclone separator and a downstream distillation tower. U.S. Pat. No. 4,750,916 to Svensson discloses a gas-solids separator device utilizing precooling and after cooling steps before and after filtration and electrostatic precipitation steps. U.S. Pat. No. 4,865,629 to Zievers et al. discloses a process for filtering fine particles from a hot gas stream by utilizing two cyclone separators located upstream of a filter. Also, U.S. Pat. No. 5,215,553 to Herman et al. discloses a two-stage mechanical separator having a concentric swirl section provided upstream of a cyclone separator. Also, U.S. Pat. No. 5,645,620 to Shenker discloses a system for separating particulates and condensable species from a gas stream.

Prior cyclone separators have been generally useful for separation of course solid materials. The cyclone separation efficiency generally drops dramatically for finer particles such as those that might be measured in a range of parts per million (ppm). Hence, it is a common practice to employ a bag house filter down stream of a cyclone separator for the removal of such finer particles.

Although these known separation devices have been found useful, further improvements in separation of particulate solids, particularly the removal of fine particulate solids, and for removal of condensable liquid fractions from hot feed gases are desired.

### SUMMARY OF INVENTION

One aspect of the invention provides a cyclone separator with liquid cooling and a system that utilizes such a cyclone separator with liquid cooling. The inside of the cyclone separator is provided with a downward flow of liquid. An inside wall of the cyclone separator is at least partially coated with downward flowing liquid. Particles in the injected gas mixture are moved to the wall of the cyclone separator by increased centrifugal force and are removed along with the downward flow of liquid. The liquid facilitates separation and removal of the particles and also cools the, cyclone separator and the gas mixture flowing through it. Cleaned and cooled gas flows out of the cyclone separator cooler.

According to another aspect of the invention, the liquid cools the gas mixture and causes condensation of condensable liquids entrained in the gas. The condensate is separated by centrifugal force and is removed along with the flow of liquid.

According to another aspect of the invention, fine particulate solids are wetted with liquid and/or absorb liquid flowing through the separator, thereby increasing the effective particle size, either by increasing the actual diameter of the particles, increasing the mass, increasing the density or a combination of such increases. The increase in the effective particle size, Dp, causes a corresponding increase in the efficiency of the cyclone separator for removing small particles. The wetted particles are moved by centrifugal force to the wall of the cyclone chamber, move downward along the wall, and are removed with the downwardly flowing liquid.

According to another aspect of the invention, the particles moved to the wall of the cyclone separator become entrapped in the downwardly flowing liquid and are removed with the liquid.

According to another aspect of the invention, in addition to removing heated particulates and thereby cooling the remaining gaseous mixture, the liquid flowing in the cyclone chamber also absorbs heat from the gas by convective cooling, radiation heat transfer and/or by evaporative cooling.

According to another aspect of the invention, liquid condensate results from cooling the gas mixture. The liquid condensate is moved to the wall of the cyclone separator by centrifugal force and becomes entrapped in the downwardly flowing liquid and is removed with the flowing liquid.

According to another aspect of the invention, the particulate containing liquid that is removed from the cyclone separator is filtered and recycled into the cyclone separator.

Other aspects and advantages of the invention will be apparent from the following description and the appended claims.

### BRIEF DESCRIPTION OF DRAWINGS

FIG. 1 is a schematic side view of a cyclone separator schematically depicting the theoretical flow gas mixture and the flow of liquid dispensed along the sidewall according to one embodiment of the invention;

FIG. 2 is a schematic top cross-sectional view of the cyclone chamber of FIG. 1 taken along section line II-II;

FIGS. 3A, 3B and 3C depict a theoretical sequence of partial sectional views of a portion of a sidewall of the cyclone separator chamber of FIGS. 1 and 2, with a liquid layer flowing along the side wall and a mixture of gas, solid particles and/or liquid condensate injected into and against the liquid layer on the side wall during operation according to one embodiment of the invention;

FIG. 3A is a first of a sequence of partial sectional views and shows a large particle impacting the water layer along the side wall;

FIG. 3B is a second of a sequence of partial sectional views and shows a large particle entrapped in the water flow and a medium particle impacting the liquid layer along the side wall;

FIG. 3C is a third of a sequence of partial sectional views and shows a medium particle entrapped in the water flow and a small particle impacting the liquid layer along the side wall;

FIG. 4 is a schematic side view of a cyclone separator, depicting gas mixture flow and water dispenser along the sidewall according to an alternative embodiment of the invention;

FIG. 5 is a schematic depiction of a small particle having a theoretical average diameter Dps and a large particle having a theoretical average diameter Dpl.

FIG. 6 is a schematic depiction of the small particle and the large particle of FIG. 5 flowing through a mist of fluid according to one aspect of the embodiment of the invention shown in FIG. 4;

FIG. 7 is a schematic depiction of the small particle and the large particle of FIGS. 5 and 6 being wetted with an accumulated layer of liquid from a liquid mist, and showing theoretically increased wetted diameters Dpsw and Dplw according to one aspect of the embodiment of FIG. 4;

FIG. 8 is a graph of theoretical separation efficiency “η” versus particle size “Dp” in which the particle size within a gas solid mixture is substantially constant; and

FIG. 9 is a graph of separation efficiency “η” versus particle size “Dp ave.” where the particles vary in size from Dpa to Dpb and Dp ave. represents an average particle size.

### DETAILED DESCRIPTION

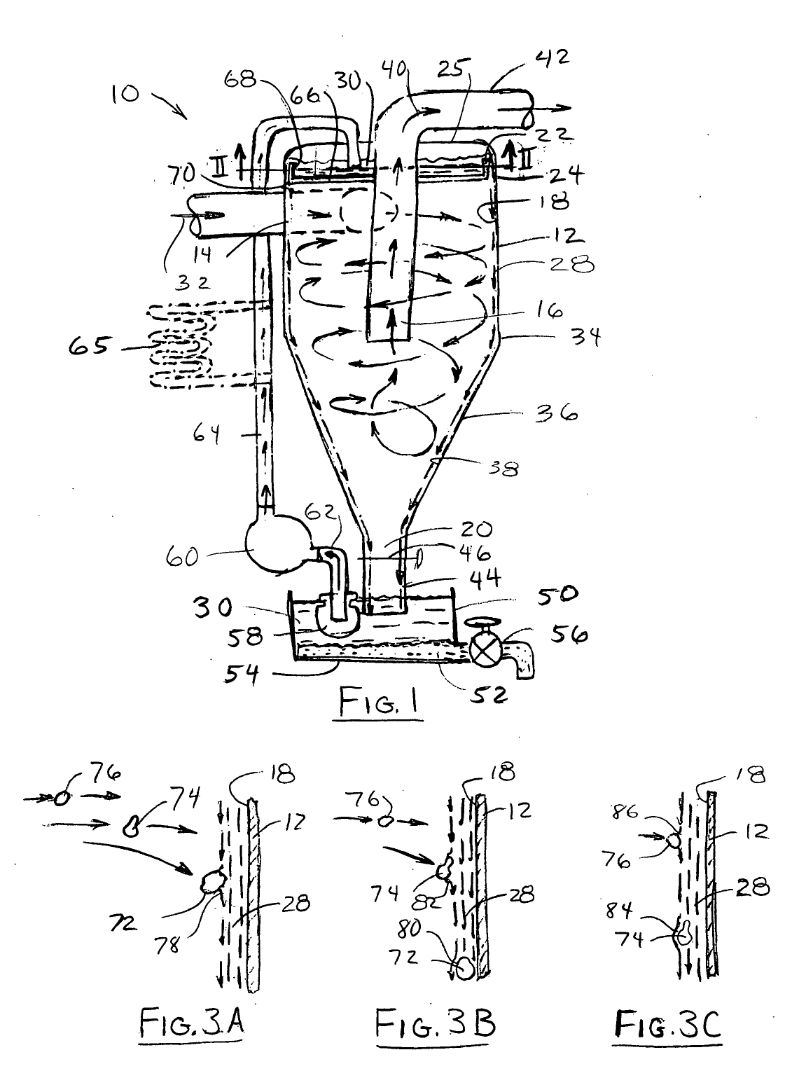

A cyclone separator cooler 10 is shown in FIG. 1. A separation chamber 12 has a gas mixture inlet 14 and a gas outlet 16. There is an inside wall 18 and a particle discharge opening 20. A liquid dispenser 22 is operatively connected at an upper end 24 of the cyclone separation chamber 12. The liquid dispenser provides a layer 28 of liquid 30 flowing along the sidewall 18 of the separation chamber 12. Particles enter the inlet 14 with the flow of gas mixture 32 and the solid particles are moved toward the inside wall 18 by centrifugal force to separate the particles from the gas mixture and are moved along the wall to be discharged. Particles encountering the layer 28 of flowing liquid 30 become entrapped in the layer 28 of liquid 30. The entrapped particles are carried out through the discharge opening 20 along with the flowing liquid 30. This facilitates separation of the particulate materials as they become entrapped and do not re-enter the vortex of swirling gas mixture 32 within the cyclone separator.

The embodiment of the invention as depicted usefully provides a substantially vertical separation chamber and the force of gravity moves the liquid 30 from a top end 24 of the separation chamber 12 to the discharge 20. Other orientations of the separation chamber 12 could be provided in which the flow of liquid 30 is only partially facilitated by gravity or in which another motivating force causes the liquid 30 to flow in the separation chamber, without departing from certain aspects of the invention.

The lower end 34 of the separation chamber 12 is connected to a truncated conical section 36. The swirling gas mixture 32 changes direction and tends to slow and loose some of its energy as it moves in a rotating vortex down the cylindrical portion of the chamber 12 until it reaches the conical section 36.

The truncated conical section 36 provides progressively decreasing diameter and reduction in cross sectional area. The swirling gas mixture 32 changes direction more rapidly as it moves in a rotating vortex down the conical section 36 of the chamber 12. As the gas mixture reaches the conical section, the same volume of gas mixture must swirl more rapidly as the diameter of the vortex decreases in the conical section 36, thereby further forcing remaining fine particles to impact against the inside surface 38 of the truncated conical section 36. The entrapped fine particles do not re-enter the swirling gas mixture, even in localized areas within the chamber 12 where the velocity of the gas might tend to increase. Particles that encounter the layer 28 of flowing liquid 30 become entrapped in the liquid and are removed along with the liquid.

The liquid layer 28 continues to flow downward along the inside conical surface 38. In some instances, the flow of liquid along the inside surface of the cylindrical wall 36 may cover less than the entire surface of the inside wall. The reduced area of the inside of the cone tends to cause the flow of liquid to more completely cover the entire reduced surface area of the conical section. Thus, a greater percentage of the smaller diameter fine particles that are moved by centrifugal force toward the conical surface 38, impact the liquid layer 28 and become entrapped in the flowing liquid 30.

A counter flow of cleaned gas 40 flows through outlet 16 and out through gas conduit 42. The truncated conical section 36 is coupled at the discharge opening 20 to a discharge tube 44. A restrictor 46, such as an orifice, a valve or a gate, is positioned in the discharge tube 44. The restrictor 46 provides appropriate back pressure for forcing cleaned gas 40 through the centrally located outlet 16 and out through the gas conduit 42 and at the same time permits the flowing liquid 30 and materials separated from the gas mixture to be discharged through the discharge tubing 44.

According to one embodiment of the invention, the liquid is selected from liquids having an affinity for the types of particulate matter or condensate as might be expected to be present in the gas mixture to be separated and cooled. For example, in an embodiment useful for the separation of carbonaceous materials such a carbon fines, carbon soot, and ash as might be associated with industrial processing of carbon or the burning of hydrocarbons, the liquid 30 can be selected from liquids for which such carbon based particles and ash have a natural affinity or attraction. For example, because carbon soot, carbon fines and silica ash are generally hydrophilic, in one embodiment, water can be selected as the liquid 30 and will be useful for separating such expected materials from a gaseous mixture 32. In another embodiment, a polar liquid other than water might be selected. In other instances where the expected particulate matter might be known to be primarily hydrophobic, another liquid may be selected. For example, where the particulate matter might be primarily hydrophobic or where the particles are particularly oleophilic, an oil might usefully be selected as the liquid 30. In another embodiment, a non-polar liquid other than oil might be selected. Other liquids and solvents might also be selected, depending upon the nature of the solids and or the condensates that might be expected in the gaseous mixture or that might be the intended target of the separation process.

The cleaned gas 40 will have had particulate matter removed in the cyclone chamber 12. The removal of the particulate matter will also act to remove the heat associated with the particulate matter. Moreover, according to another aspect of the invention, the gas mixture 32 is caused to cool through contact with the layer 28 of flowing liquid 30, further causing condensable liquid entrained in the mixture of gas 32 to condense and separate by centrifugal force outwardly to the inside wall 36 and, where the condensate encounters the flowing layer 28 of liquid 30, into the liquid 30.

At the discharge tube 44 a collection reservoir 50 is provided to collect the discharged liquid and entrained particulate matter and/or condensate. Heavy particulate matter, 52 settles as sludge to the bottom 54 and is removed by a sludge removal device 56. For an example, the sludge removal device 56 is schematically represented as a valve and nozzle.

The liquid 30 is preferably filtered at filter 58 and recycled with a pump 60. The filtered liquid 30 is pumped with pump 60 from the reservoir 50, through filter 58 at an inlet 62, and upward through a pipe 64 to the liquid dispenser 22. In one alternative embodiment, the reservoir also acts to allow the liquid to cool before recycling. In another alternative embodiment, the liquid 30 may be cooled by a heat exchanger 65 (shown as an alternative with phantom lines).

The liquid dispenser 22 is depicted, by way of example, as a pan 66 laterally disposed across the top end 24 of the separation chamber 12. The pan 66 is provided with a circumferential lip 68 having a plurality of orifices 70 to provide a metered flow of liquid 30 in a layer 28 along the inside wall 18. In an alternative embodiment, it will be understood that the plurality of orifices could be provided intermittently along the wall to form regions of liquid flow. Alternatively, the plurality of orifices 70 could be uniformly and closely spaced to form a substantially continuous layer of liquid flowing over the entire inside surface 18. In yet another alternative embodiment, the flow of liquid could be provided by a substantially continuous annular gap formed adjacent to the inside wall 18.

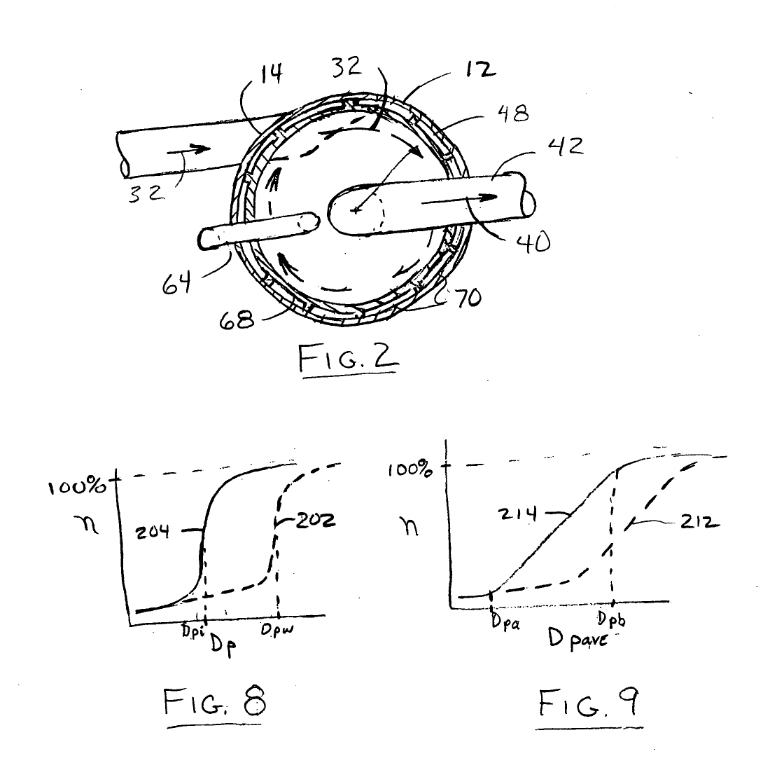

With reference also to FIG. 2, it will be understood that the separation chamber 12 is advantageously a cylindrically shaped chamber having a central axis 48. The inlet 14 is offset from a central axis 48 and preferably is directed to provide the flow of gas mixture 32 with momentum in a direction substantially tangential to the inside surface 18 at the entrance 14.

FIGS. 3A, 3B, and 3C show in a sequence, the action of the cyclone separator with liquid flow 28 along the inside sidewall 18, to move the particles outward and to entrap them in the flow 28 of liquid 30. To demonstrate a range of fine particle sizes, a relatively large particle 72, a medium size particle 74 and a relatively small size particle 76 are shown in motion outward toward the side wall 18 of the separation chamber 12. It will be understood that the density of particles in a gas mixture can vary depending upon the composition of the individual particles, such that the diameter alone is not determinative of the mass and the centrifugal force on the particle in the cyclone separator. When discussing separation of particles in cyclone separators it is a common practice to make an assumption that the particles are generally of the same average density, such that the relative mass can be compared in terms of the size of the particle of the diameter of the particle “Dp.” However, for purposes of discussion it will be understood that the diameter “Dp” is the effective diameter or the diameter that would be required for a particle having an average density to provide the actual mass of a given particle. In FIG. 3A, and assuming that all of the particles are moving with approximately the same velocity with the gas mixture 32, the particles 72 having a relatively large effective diameter could be expected to have the greatest centrifugal force exerted on them and to therefore first impact the layer 28 of flowing liquid 30. A liquid chosen to have an affinity or attraction to the particles expected in the gas mixture would act to wet the surface of the particle 72 at 78.

In FIG. 3B, the affinity of the particle and liquid for each other and the surface tension forces within the liquid will further act to encapsulate and entrap the particle 72 in the liquid 30. The medium size particle 74 will also impact the layer 28 of liquid 30 at some point, typically after the larger particle 72 impacts the liquid layer 28. The medium particle 74 will be wetted by and thereby entrapped in the liquid 30.

FIG. 3C shows the medium size particle 74 fully encapsulated and entrapped within the flowing layer 28 of liquid 30. The small particles 76 will impact the layer 28 of liquid 30 and similarly will become entrapped. This will continue to occur along the side wall 18 and also along the inside conical surface 38 as the diameter of the separation chamber diminishes in the conical section 36. The liquid layer thereby increases the efficiency of particle removal and simultaneously cools the cyclone separator and the gas flowing through the separator and cooler combination.

An alternative embodiment of a cyclone separator cooler 100 is shown in FIG. 4. A separation chamber 112 has a gas mixture inlet 114 and a gas outlet 116, an inside wall 118 and a particle discharge 120. A liquid dispenser 122 is operatively connected at an upper end 124 of the cyclone separation chamber 112. The liquid dispenser 122 according to this alternative embodiment provides a plurality of spray nozzles 190. The spray nozzles 190 provide a mist 192 of liquid through which the gas mixture 132, including entrained particulate matter, is passed. The spray nozzles 190 also provide an accumulation of liquid 130 on the inside surface 118 of the chamber 112. The accumulation of liquid 130 on the wall 118 is sufficient to provide a layer 128 of liquid 130 that flows, as by the force of gravity, along the inside wall 118 of the separation chamber 112.

Particles entrained in the gas mixture 132 enter the inlet 114 with the flow of gas mixture 132 and are moved toward the inside wall 118 by centrifugal force. The particles pass through the liquid mist 192 and are wetted by the liquid droplets that spray from the nozzles 190 to form the mist 192. The particles are thus wetted or coated with the liquid 130, thereby increasing their effective diameter from an original diameter Dupo of each wetted particle to a larger effective wetted particle diameter, Dow. The wetted particles are caused by centrifugal force to impact against the side wall 118 or the liquid layer 128 and become entrapped in the layer 128 of liquid 130. The entrapped particles accumulate in the liquid layer 128 created by the liquid mist 192 on the inside wall 118 and are carried out of the separation chamber 112 through the discharge opening 120 together with the layer 128 of flowing liquid 130.

The lower end 134 of the separation chamber 112 is connected to a truncated conical section 136. The gas mixture 132 continuously changes direction along the inside wall 118 and tends to slow and loose some of its energy as it moves in a swirling motion or a rotating vortex down the cylindrical portion of the chamber 112. The swirling gas mixture 132 moves from the cylindrical portion 118 into the truncated conical section 136. The truncated conical section 136 provides progressively decreasing diameter and reduction in cross sectional area. The swirling gas mixture 132 changes direction more rapidly as it moves in a rotating vortex toward the discharge 120 of the conical section 136 of the chamber 112. As the gas mixture reaches the conical section the same volume of gas mixture must swirl and change direction more rapidly as the diameter of the vortex decreases in the conical section 136, thereby further forcing remaining fine particles to impact against the inside surface 138 of the truncated conical section 136. Particles that encounter the layer 128 of flowing liquid 130 become entrapped. The entrapped fine particles do not re-enter the swirling gas mixture, even in localized areas within the chamber 112 where the velocity of the gas might tend to increase. The particles are removed along with the liquid 130 through the discharge 120.

The truncated conical section 136 is coupled at the discharge opening 120 to a discharge tube 144 having a restrictor 146 so that the appropriate pressure is maintained for proper discharge of liquid and entrained particles, while out-letting gas 140 through the centrally located outlet 116 and the gas conduit 142. Thus a counter flow of cleaned gas 140 is produced and exits through outlet 116 and is moved out through gas conduit 142.

The cleaned gas 140 will have had particulate matter removed in the cyclone chamber 112. The removal of the particulate matter will also act to remove from the gaseous mixture the heat associated with the particulate matter. Moreover, according to another aspect of the invention, the gas mixture 132 is caused to cool through contact with the liquid mist 192 and also with the layer 128 of a flowing liquid 130. The cooling of the gas mixture further causes condensable liquid that may be entrained in the mixture of gas 132, to condense and separate by centrifugal force outwardly toward the inside wall 118 and into the layer 128 of flowing liquid 130 that the condensate encounters.

At the discharge tube 144 a collection reservoir 150 is provided to collect the discharged liquid and entrapped particulate matter and/or condensate. While one embodiment provides for the settling of heavy particulate matter as sludge, which is then removed by a sludge removal device, in an alternative embodiment the entire amount of collected liquid with the entrapped particulate matter and any condensate may be removed for processing, filtering, recycling and/or proper disposal at another location. For an example, a valve and nozzle is depicted to represent such a removal device 156, by which the mixture of liquid and particulate matter is removed.

In the alternative embodiment shown in FIG. 4, a pump 160 receives liquid 130 from a source 162 the liquid 130 is pumped trough pipe 164 to the water dispenser 122. A pressure regulator valve 168 may be provided interposed along the pipe 164 for delivering the liquid through a pipe 188 to the nozzles 190. It will be understood that a fresh supply of liquid 130 may be provided where available, or usefully, the liquid recovered from the reservoir 150 may be processed and recycled to conserve resources.

FIG. 8 shows a typical efficiency graph for a cyclone separator where the efficiency η is generally dependent on the effective particle size Dp. In this graph the dashed line 202 represents the efficiency η for a typical cyclone separator and the solid line 204 represents the efficiency that can be expected for a cyclone separator with liquid cooling according to an embodiment of the present invention. An entrained particle initially has a small size Dpi, and then the size effectively becomes larger by the wetting action within the inventive separator cooler up to a larger size Dpw and is more easily separated from the gas. Alternatively, the small particles are more efficiently entrapped in the layer of liquid to increase the separation efficiency for smaller size particles as if they were particles having a larger size, or an effective size of Dpw. Thus the curve 204 for the efficiency of the inventive cyclone separator cooler is shifted to the left, toward a higher efficiency for smaller particles.

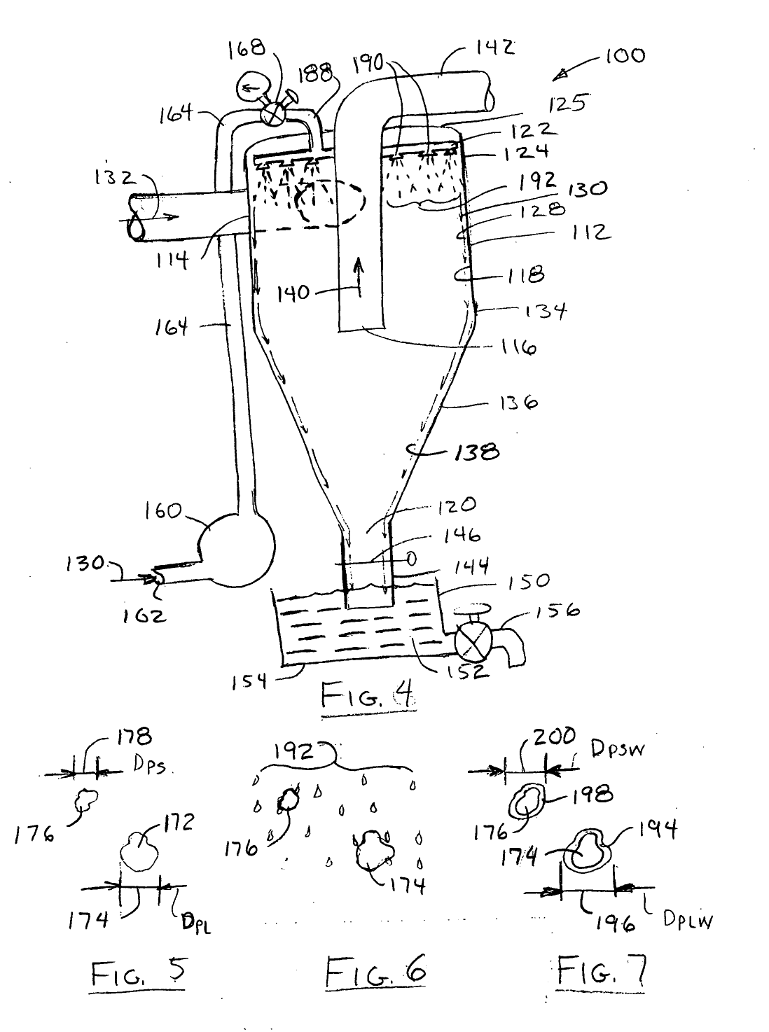

FIG. 9 shows a typical efficiency graph for a cyclone separator where the efficiency η is generally dependent on the effective particle size Dp where the range of particle sizes Dpa to Dpb for the gas mixture is expected to vary more widely than the particle sizes of FIG. 8. The dashed line 212 represents the efficiency η for a typical cyclone separator and the solid line 214 represents the efficiency that can be expected for a cyclone separator with liquid cooling according to an embodiment of the present invention.

Referring to FIGS. 8 and 9 it will be understood that although the slopes of the curves 212 and 214 in FIG. 9 are generally less steep than the slopes of the curves 202 and 204 in FIG. 8, in each case, the particles that initially have a smaller size, effectively become larger by the wetting action within the inventive cyclone separator cooler and/or are more efficiently entrapped in the layer of liquid to increase the separation efficiency for smaller size particles.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A cyclone separator cooler comprising:
a separation chamber having an inlet, an outlet, an inside wall and a particle discharge; and
a liquid dispenser operatively connected at a top end of the cyclone separation chamber for providing a layer of liquid flowing by the force of gravity along the inside wall of the separation chamber to entrap separated particles in the liquid and to carry the entrapped particles out the discharge.

2. The cyclone separator cooler of claim 1, wherein the separation chamber comprises:
a cylindrical side wall having a central axis, a top end and a bottom end; a top connected to and enclosing the top end of the cylindrical sidewall;
a truncated conical bottom section having a large diameter connected to and coaxial with the bottom end of the cylindrical side wall;
an inlet, through the cylindrical sidewall adjacent to the top end and offset from the central axis, to inject a mixture of gas and liquid and/or solid material with a swirling motion into the chamber;
an outlet extending from a central location inside the chamber and out through the top; and
a discharge tube connected at a small diameter of the truncated conical bottom.

3. The cyclone separator cooler of claim 1, wherein the liquid comprises water.

4. The cyclone separator cooler of claim 3, wherein a solid material in the gas mixture comprises a hydrophilic material.

5. The cyclone separator cooler of claim 1, wherein the liquid comprises a polar liquid.

6. The cyclone separator cooler of claim 1, wherein the liquid comprises oil.

7. The cyclone separator cooler of claim 6, wherein a solid material in the gas mixture comprises an oleophilic material.

8. The cyclone separator cooler of claim 1, wherein the liquid comprises a non-polar liquid.

9. The cyclone separator cooler of claim 1, wherein the liquid comprises a solvent.

10. The cyclone separator cooler of claim 1, wherein the liquid dispenser comprises a pan across the top of the separation chamber for holding a quantity of liquid and having an opening between the pan and an inside wall of the chamber to allow liquid to flow along the sidewall.

11. The cyclone separator cooler of claim 10, wherein the opening between the pan and an inside wall of the chamber comprise a plurality of openings spaced circumferentially around the pan.

12. The cyclone separator cooler of claim 10, wherein the opening between the pan and an inside wall of the chamber comprise a substantially continuous annular opening circumferentially around the pan.

13. The cyclone separator cooler of claim 1, wherein the liquid dispenser comprises at least one nozzle operatively connected for spraying a liquid into the separation chamber.

14. The cyclone separator cooler of claim 13, wherein the at least one nozzle sprays liquid at least partially onto an inside wall of the separation chamber.

15. The cyclone separator cooler of claim 13, wherein the at least one nozzle comprises a plurality of nozzles.

16. The cyclone separator cooler of claim 15, wherein at least one of the plurality of nozzles is operatively connected to spray liquid at least partially onto an inside wall of the separation chamber.

17. A cyclone chamber comprising:
a first end;
a cylindrical side wall connected to the first end;
a truncated conical section having a large diameter connected to the side wall;
an inlet offset from the central axis of the cylindrical sidewall to inject a mixture of gas and liquid and/or solid material with a swirling motion into the chamber;
an outlet extending from a central location inside the chamber and out through the first end for removing cleaned gas;
a discharge tube connected at a small diameter of the truncated conical section for discharging liquid and solid material separated from the mixture of gas, liquid and solid material; and
a liquid dispenser operatively connected to the chamber for providing a layer of liquid flowing along an inside surface of the side wall, an inside surface of the conical section, and out of the discharge tube.

18. The cyclone chamber of claim 17, wherein the liquid comprises water.

19. The cyclone chamber of claim 18, wherein a solid material in the gas mixture comprises a hydrophilic material.

20. The cyclone separator cooler of claim 17, wherein the liquid comprises a polar liquid.

21. The cyclone chamber of claim 17, wherein the liquid comprises oil.

22. The cyclone chamber of claim 21, wherein a solid material in the gas mixture comprises an oleophilic material.

23. The cyclone separator cooler of claim 17, wherein the liquid comprises a non-polar liquid.

24. The cyclone chamber of claim 17, wherein the liquid comprises a solvent.

25. The cyclone chamber of claim 17, wherein the liquid dispenser comprises a pan across the first end of the cylindrical side wall for holding a quantity of liquid and having a circumferential opening between the pan and an inside surface of the cylindrical side wall to allow liquid to flow along the side wall.

26. The cyclone chamber of claim 17, wherein the liquid dispenser comprises a nozzle operatively connected for spraying a liquid into the cyclone chamber.

27. A cyclone chamber comprising:
a top;
a cylindrical side wall connected to the top;
a truncated conical bottom section having a large diameter connected to the side wall;
an inlet offset from the central axis of the cylindrical sidewall to inject a mixture of gas and liquid and/or solid material with a swirling motion into the chamber;
an outlet extending from a central location inside the chamber and out through the top;
a discharge tube connected at a small diameter of the conical bottom; and
a liquid dispenser operatively connected at the top of the chamber for providing a layer of liquid flowing along an inside surface of the side wall and out of the discharge tube.

28. A cyclone separator cooler comprising:
a chamber including: a cylindrical side wall having a central axis, a top end and a bottom end; a top closure connected to and enclosing the top end of the cylindrical sidewall; a truncated conical bottom section having a large diameter connected to and coaxial with the bottom end of the side wall; an inlet through the cylindrical sidewall adjacent to the top end and offset from the central axis to inject a mixture of gas having entrained liquid and/or solid material and to cause a swirling motion to the gas mixture as it enters the chamber; an outlet extending from a central location inside the chamber and out through the top closure; a discharge tube connected at a small diameter of the truncated conical bottom; and
a liquid dispenser operatively connected at the top end of the chamber for providing a layer of liquid flowing by the force of gravity along the inside of the side wall and out of the discharge tube.

29. The cyclone separator cooler of claim 28, wherein the liquid comprises water.

30. The cyclone separator cooler of claim 29, wherein a solid material in the gas mixture comprises a hydrophilic material.

31. The cyclone separator cooler of claim 28, wherein the liquid comprises a polar liquid.

32. The cyclone separator cooler of claim 28, wherein the liquid comprises oil.

33. The cyclone separator cooler of claim 32, wherein a solid material in the gas mixture comprises an oleophilic material.

34. The cyclone separator cooler of claim 28, wherein the liquid comprises a polar liquid.

35. The cyclone separator cooler of claim 28, wherein the liquid comprises a solvent.

36. The cyclone separator cooler of claim 28, wherein the liquid dispenser comprises a pan across the top of the separation chamber for holding a quantity of liquid and having an opening between the pan and an inside wall of the chamber to allow liquid to flow along the sidewall.

37. The cyclone separator cooler of claim 36, wherein the opening between the pan and an inside wall of the chamber comprise a plurality of openings spaced circumferentially around the pan.

38. The cyclone separator cooler of claim 36, wherein the opening between the pan and an inside wall of the chamber comprise a substantially continuous annular opening circumferentially around the pan.

39. The cyclone separator cooler of claim 28, wherein the liquid dispenser comprises at least one nozzle operatively connected for spraying a liquid into the separation chamber.

40. The cyclone separator cooler of claim 39, wherein the at least one nozzle sprays liquid at least partially onto an inside wall of the separation chamber.

41. The cyclone separator cooler of claim 39, wherein the at least one nozzle comprises a plurality of nozzles.

42. The cyclone separator cooler of claim 41, wherein the plurality of nozzles are operatively connected to spray liquid at least partially onto an inside wall of the separation chamber.
